(19) United States
(12) Patent Application Publication
(10) Pub. No.: US 2022/0241933 A1
(43) Pub. Date: Aug. 4, 2022

(54) WRENCH INCLUDING OPENING BETWEEN GRIPPING PORTIONS ADJUSTABLE RAPIDLY

(71) Applicant: Hong Ann Tool Industries Co., Ltd., Taichung City (TW)

(72) Inventor: Cheng-Wei SU, Taichung City (TW)

(21) Appl. No.: 17/573,709

(22) Filed: Jan. 12, 2022

(30) Foreign Application Priority Data
Feb. 4, 2021 (TW) 110104297

(51) Int. Cl. B25B 13/22

(52) U.S. Cl. CPC B25B 13/22

(57) ABSTRACT

A wrench including a first wrench body having a first gripping portion, a first connecting portion, and a second connecting portion. The wrench also includes a second wrench body having a second gripping portion, a third connecting portion, and a first engaging portion. The first and the second gripping portions cooperatively delimit an opening therebetween. The first and the third connecting portions are movably connected with each other. A locking device is coupled to the first and the second wrench bodies. The locking device includes a locking member movably connected with the second connecting portion. The locking member has a second engaging portion and is operably movable between a first position in which the first and the second engaging portions engage with each other, and a second position in which the first and the second portions disengage from each other.

### BACKGROUND OF THE INVENTION

### 1. Field of the Invention

The present invention relates to a tool including two gripping portion and an opening delimited between the gripping portion s and, particularly, to a wrench including one gripping portion movable relative to another gripping portion and an opening delimited between the gripping portions being rapidly adjustable.

### 2. Description of the Related Art

TW Pat. No. 1576215 discloses a pipe wrench including a fixed jaw body and a sliding jaw body slidably disposed on the fixed jaw body. The fixed jaw has a handle portion and a first jaw portion. The sliding jaw body has a body portion, a through hole, at least one first reinforcing rib and a second jaw portion. The through hole extends through opposite sides of the body portion and is parallel to a first surface of the body portion. The through hole slidably receives the fixed jaw body. The first reinforcing rib is disposed on the first surface and extends in a direction away from the through hole. The second jaw portion on the main body portion corresponds to the first jaw portion. The first and the second jaw portions can move close to or away from each other. The sliding jaw body is engaged with a worm gear which is operably moved to adjust the position of the sliding jaw body relative to the fixed jaw body. However, it is still desirable to design a mechanism that allows a user to change the position of the sliding jaw body relative to the fixed jaw body rapidly.

The present invention is, therefore, intended to obviate or at least alleviate the problems encountered in the prior art.

### SUMMARY OF THE INVENTION

According to the present invention, a wrench including opening between gripping portions adjustable rapidly including a first wrench body having a first gripping portion, a first connecting portion, and a second connecting portion. The wrench also includes a second wrench body having a second gripping portion, a third connecting portion, and a first engaging portion. The first and the second gripping portions cooperatively delimit an opening therebetween between which a workpiece is adapted to be held. The first and the third connecting portions are movably connected with each other such that the first and the second wrench bodies are movably coupled to each other. The second gripping portion is movable toward and away from the first gripping portion and the opening varies in size in response to the movement of the second wrench body relative to the first wrench body. Further, a locking device is coupled to the first and the second wrench bodies. The locking device includes a locking member movably connected with the second connecting portion such that the locking device is movably coupled to the first wrench body. The locking member has a second engaging portion and is operably movable between a first position in which the first and the second engaging portions engage with each other and the second wrench body is able to be rapidly moved toward the first wrench body to bring the second gripping portion toward the first gripping portion and stopped from moving away from the first wrench body, and a second position in which the first and the second portions disengage from each other and the second wrench body is able to be rapidly moved toward and away from the first wrench body.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the abstract is to enable the public generally, and especially scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a wrench including opening between gripping portions adjustable rapidly in accordance with a first embodiment of the present invention.

FIG. 2 is an exploded perspective view of the wrench of FIG. 1.

FIG. 3 is a cross-section view of the wrench of FIG. 1.

FIG. 4 is another cross-section view of the wrench of FIG. 1.

FIG. 5 is another cross-sectional view illustrating the gripping portions adapted to be moved relative to one another and including an opening therebetween adjustable in response to relative positions of the gripping portions.

FIG. 6 is a perspective view showing the wrench in an open position.

FIG. 7 is a perspective view of a wrench including opening between gripping portions adjustable rapidly in accordance with a second embodiment of the present invention.

FIG. 8 is an exploded perspective view of the wrench of FIG. 7.

FIG. 9 is another cross-sectional view of the wrench of FIG. 7.

FIG. 10 is a perspective view of a wrench including opening between gripping portions adjustable rapidly in accordance with a third embodiment of the present invention.

### DETAILED DESCRIPTION OF THE INVENTION

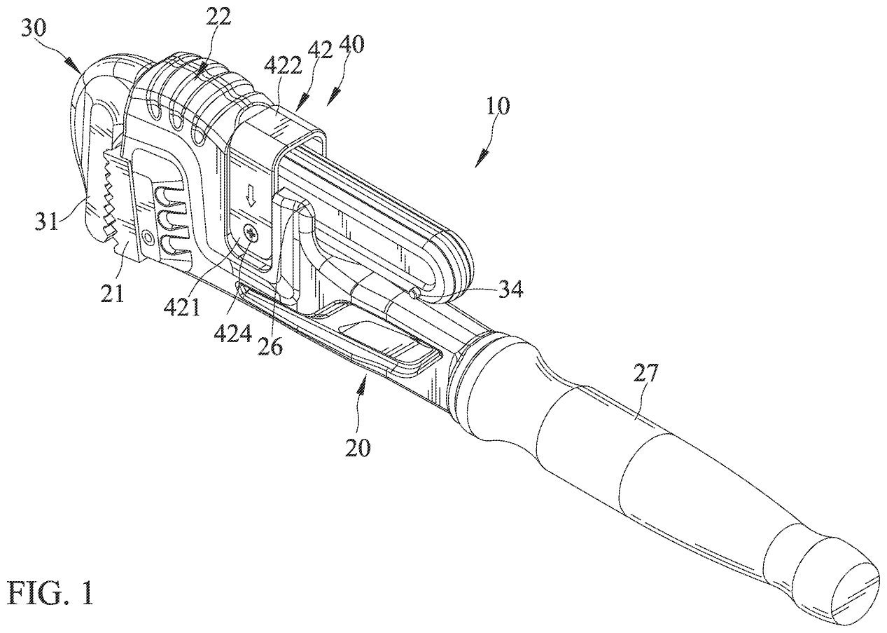

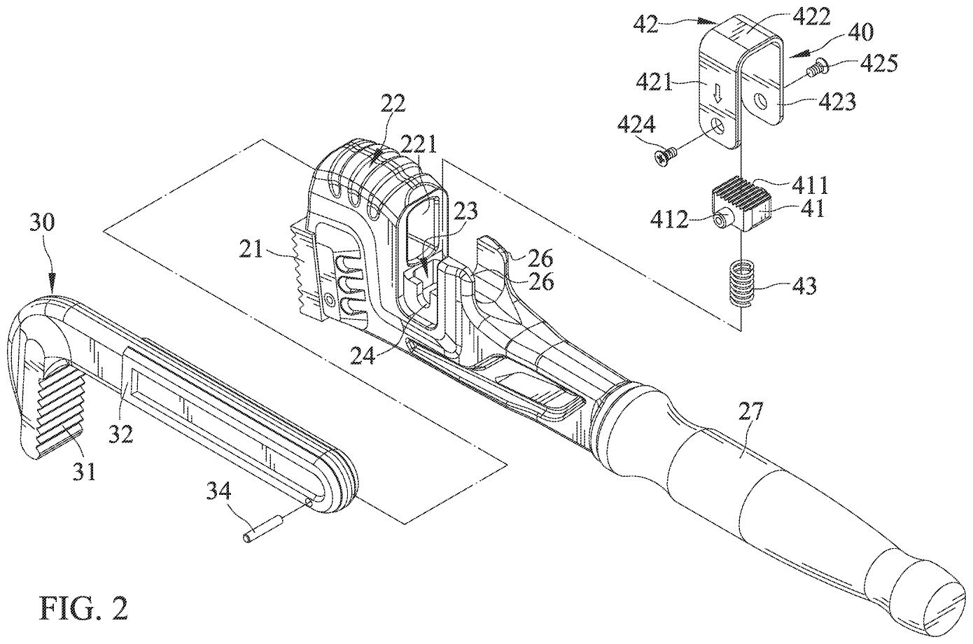

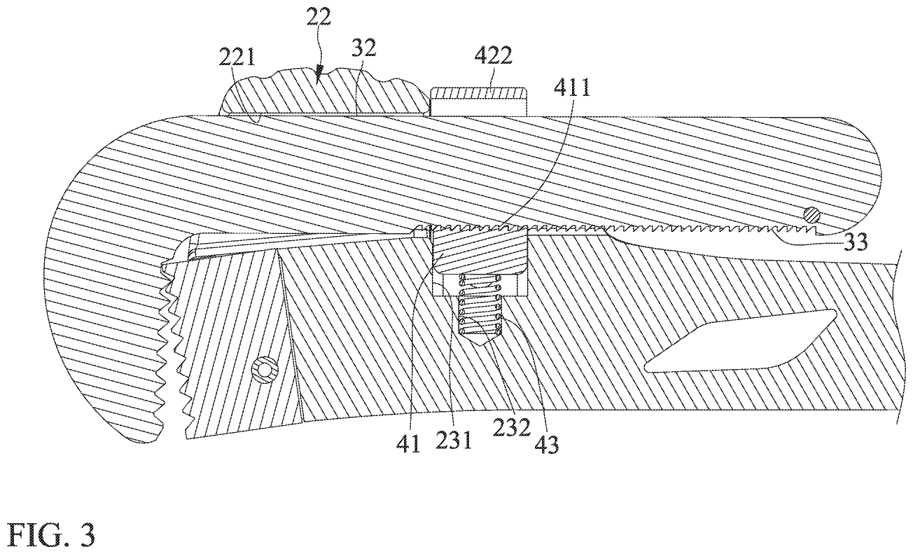

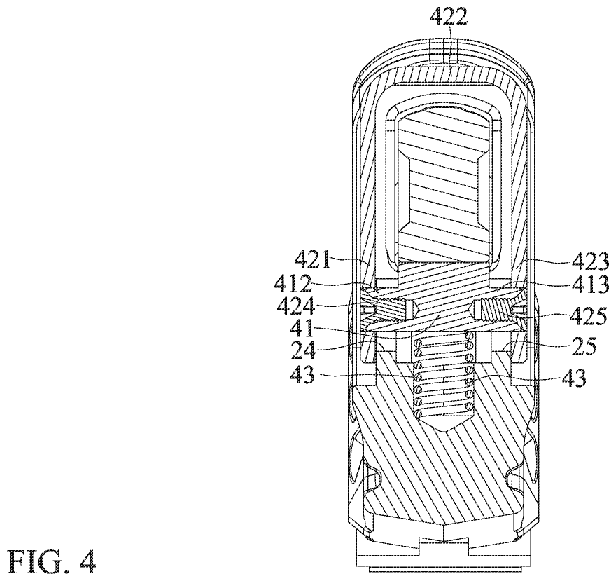

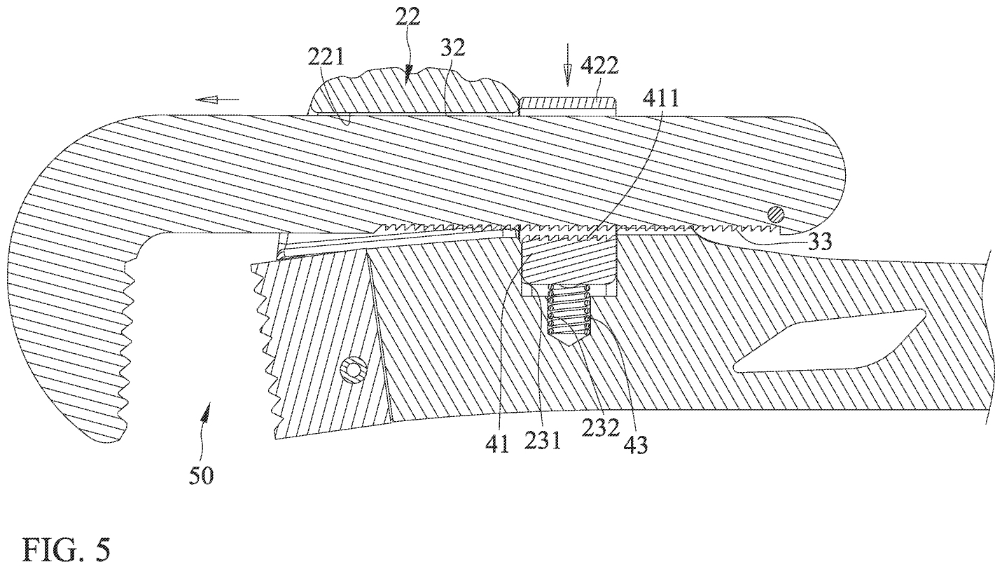

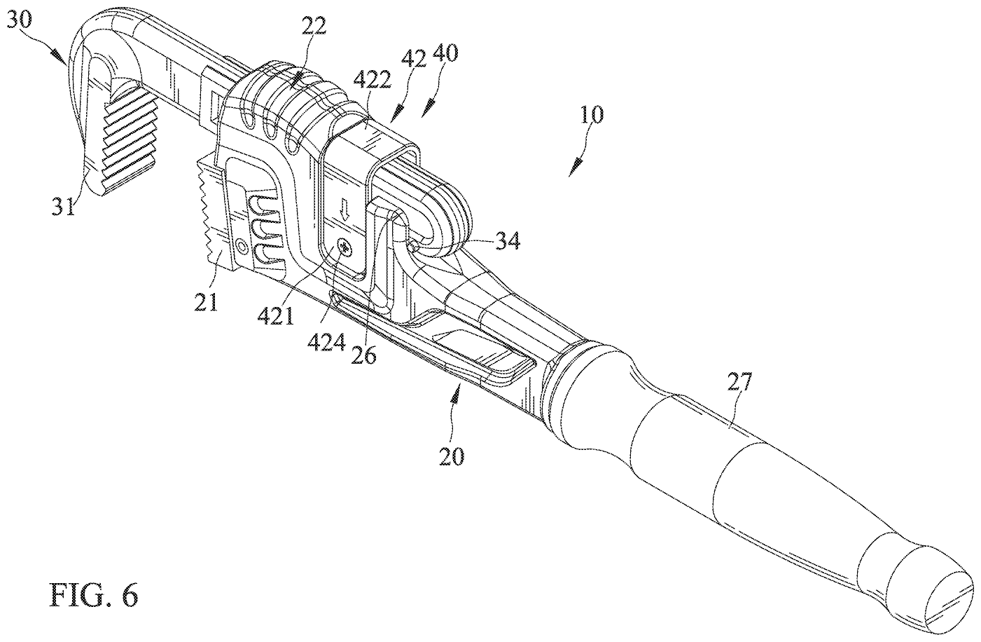

FIGS. 1 through 6 show a wrench 10 including opening between gripping portions adjustable rapidly in accordance with a first embodiment of the present invention. The wrench 10 includes a first wrench body 20 and a second wrench body 30. The first and the second wrench bodies 20 and 30 are movably coupled and cooperate to engage with a workpiece.

The first wrench body 20 has a first gripping portion 21, a first connecting portion 22, and a second connecting portion 23. The first wrench body 20 has a grip portion 27 defining a grip portion of the wrench 10. The first and the second connecting portions 22 and 23 are positioned between the first gripping portion 21 and the grip portion 27.

The second wrench body 30 has a second gripping portion 31, a third connecting portion 32, and a first engaging portion 33. The first and the second gripping portions 21 and 31 cooperatively delimit an opening 50 therebetween between which the workpiece is adapted to be held. Both the first and the gripping portions 21 and 31 have teeth to prevent the workpiece from loosening. The first and the third connecting portions 22 and 32 are movably connected with each other such that the first and the second wrench bodies 20 and 30 are movably coupled to each other. The third connecting portion 32 is inserted through the first connecting portion 22. The first connecting portion 22 defines a through hole 221 and the third connecting portion 32 is in a form of a shaft. The second gripping portion 31 is movable toward and away from the first gripping portion 21 and the opening 50 varies in size in response to the movement of the second wrench body 30 relative to the first wrench body 20.

Further, the wrench 10 includes a locking device 40 coupled to the first and the second wrench bodies 20 and 30. The locking device 40 includes a locking member 41 movably connected with the second connecting portion 23 such that the locking device 40 is movably coupled to the first wrench body 20. The locking member 41 has a second engaging portion 411 and is operably movable between a first position in which the first and the second engaging portions 33 and 411 engage with each other and the second wrench body 30 is able to be rapidly moved toward the first wrench body 20 to bring the second gripping portion 31 toward the first gripping portion 21 and stopped from moving away from the first wrench body 20, and a second position in which the first and the second engaging portions 33 and 411 disengage from each other and the second wrench body 30 is able to be rapidly moved toward and away from the first wrench body 20. The locking member 41 has at least one mounting portion 412 movably connecting with the second connecting portion 23 to movably connect with the second connecting portion 23. The second connecting portion 23 has at least one retaining structure 24 with which the at least one mounting portion 412 is fit correspondingly. The at least one mounting portion 412 includes a first mounting portion 412 and a second mounting portion 413, and the first and the second mounting portions 412 and 413 extend from opposite lateral sides of the locking member 41. The at least one retaining structure 24 includes a first retaining structure 24 and a second retaining structure 25, and the first and the second retaining structures 24 and 25 are at opposite lateral sides of the second connecting portion 23. The at least one mounting portion 412 is in a form of a protrusion. The at least one retaining structure 24 is in a form of a slot. When the at least one mounting portion 412 is fit with the at least one retaining structure 24, the slot receives the protrusion. The locking member 41 has a greater width than the resilient member 43. The locking member 41 is biased by a resilient member 43. The resilient member 43 is received by the second connecting portion 23. The second connecting portion 23 defines a cavity. The cavity has a first section 231 receiving the locking member 41 and a second section 232 receiving the resilient member 43. When the locking member 41 moves from the first position to the second position, the resilient member 43 is compressed.

The locking device 40 also includes an actuator 42 connected with the locking member 41 and adapted to be input to actuate the locking member 41. The actuator 42 has at least one linking portion 421 with which the at least one mounting portion 412 is fit correspondingly. The at least one mounting portion 412 is in a form of a protrusion. The at least one linking portion 421 defines a hole. When the at least one mounting portion 412 is fit with the at least one linking portion 421, the protrusion inserts into the hole. The at least one linking portion 421 includes a first linking portion 421 and a second linking portion 423. The actuator 42 is U-shaped and includes an extension 422 extending transversely between the first and the second linking portions 421 and 423 and on which a user can apply force to operate the actuator 42 to actuate the movement of the locking member 41. The locking member 41 and the actuator 42 includes at least one fastener 424 engaging therewith to secure the locking member 41 with the actuator 42. The at least one fastener 424 has outer threads adapted to engage with inner threads. The at least one fastener 424 includes a first fastener 424 and a second fastener 425, and the first fastener 424 engages with the first mounting portion 412 and the first linking portion 421, and the second fastener 425 engages with the second mounting portion 413 and the second linking portion 423.

The opening 50 is increasable to an extent when the second wrench body 30 is limited from moving relative to the first wrench body 20. The second wrench body 30 includes a limiter 34 disposed thereon and the first wrench body 20 has at least one limiting structure 26 adapted to hold the limiter 34 such that the limiter 34 abuts the at least one limiting structure 26 when the second wrench body 30 is limited from moving relative to the first wrench body 20. The limiter 34 protrudes from the third connecting portion 32 and extends transversely to a longitudinal length the third connecting portion 32. The limiter 34 is in a form of a protrusion. The second connecting portion 23 is positioned between the at least one limiting structure 26 and the first connecting portion 22. The at least one limiting structure 26 includes two limiting structures disposed oppositely and spaced from each other.

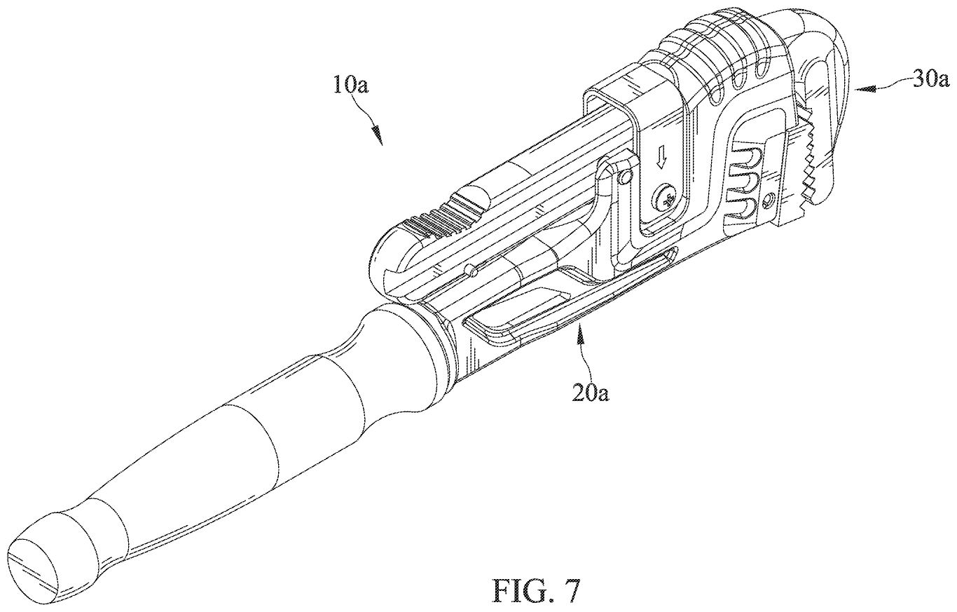

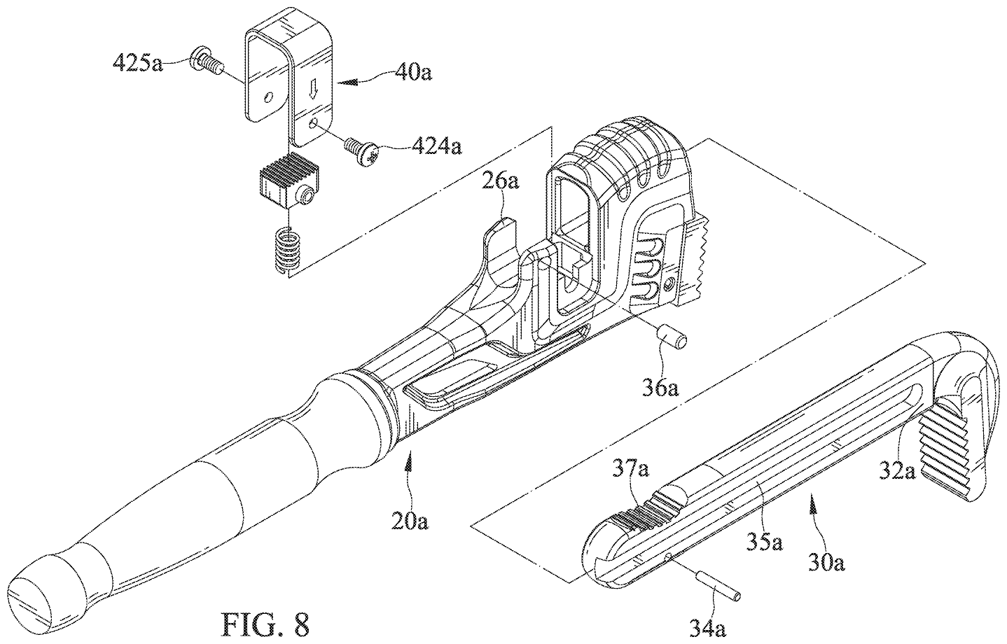

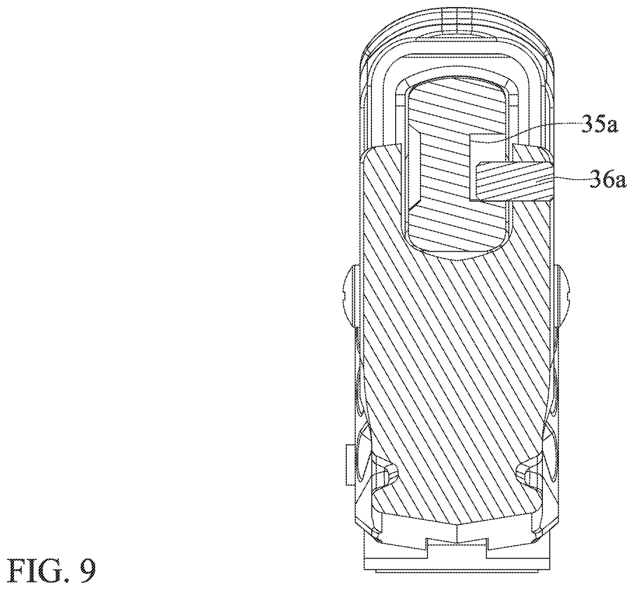

FIGS. 7 through 9 show a wrench 10a including opening between gripping portions adjustable rapidly in accordance with a second embodiment of the present invention, and the same numbers are used to correlate similar components of the first embodiment, but bearing a letter a. The wrench 10a includes a first wrench body 20a similar to the first wrench body 20, a second wrench body 30a similar to the second wrench body 30, and a locking device 40a similar to the locking device 40, and thus the descriptions are omitted for the sake of brevity. Similarly, the second wrench body 30a includes a limiter 34a disposed thereon and the first wrench body 20a has at least one limiting structure 26a adapted to hold the limiter 34a such that the limiter 34a abuts the at least one limiting structure 26a when the second wrench body 30a is limited from moving relative to the first wrench body 20a.

The second embodiment is different from the first embodiment in that it includes a stabilizing structure which prevents the second wrench body 30a from shaking when moving relative to the first wrench body 20a and to smooth the relative movement of the first and the second wrench bodies 20a and 30a, thereby facilitating rapid relative movement between the first and the second wrench bodies 20a and 30a. One of the first and the second wrench bodies 20a and 30a includes a stabilizer 36a of the stabilizing structure disposed thereon and movable on the other of the first and the second wrench bodies 20a and 30a in a guided manner. The other of the first and the second wrench bodies 20a and 30a includes a guide 35a along which the stabilizer 36a moves. The at least one limiting structure 26a includes the stabilizer 36a disposed thereon. The limiter 34a protrudes from the third connecting portion 32a and extends transversely to a longitudinal length the third connecting portion 32a. The stabilizer 36a also protrudes from the third connecting portion 32a and extends transversely to the longitudinal length the third connecting portion 32a. The guide 35a is in a form of a groove. The guide 35a extends on and along the longitudinal length of the third connecting portion 32a. Furthermore, the second embodiment is different from the first embodiment in that it includes an operation aid structure 37a which allows a user to put a hand frictionally on the third connecting portion 32a to facilitate the operation of moving the second wrench body 30a relative to the first wrench body 20a. The operation aid structure 37a has a surface which is rugged. The surface of the operation aid structure 37a extends curvedly. Thus, the second wrench body 30a is able to be rapidly moved toward the first wrench body 20a, or vice versa.

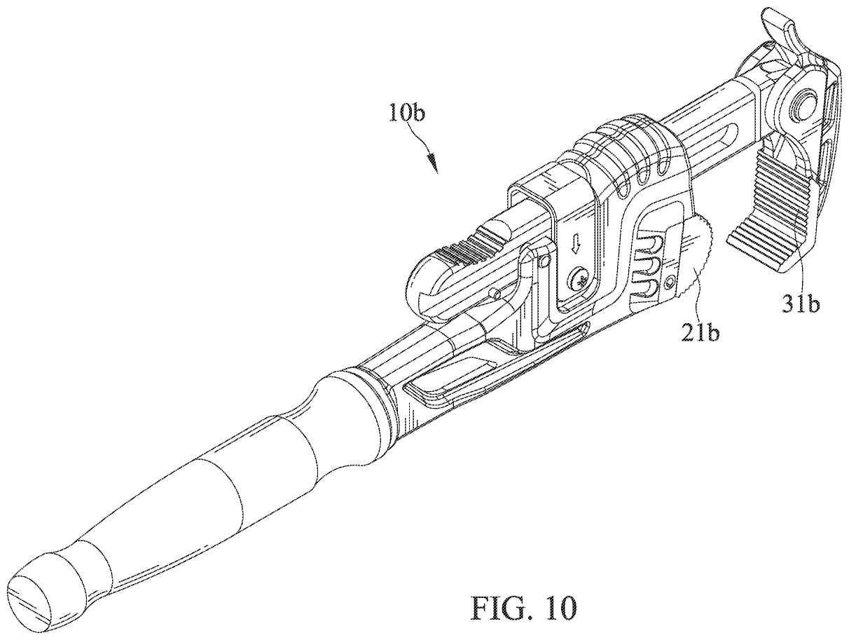

FIG. 10 shows a wrench 10b including opening between gripping portions adjustable rapidly in accordance with a third embodiment of the present invention, and the same numbers are used to correlate similar components of the first embodiment, but bearing a letter b. The third embodiment is similar to the second embodiment except that a second gripping portion 31b is pivotally movable and the contours of gripping surfaces of the first and the second gripping portions 21b and 31b. The gripping surface of the first gripping portion 21b extends curvedly rather than linearly. The gripping surface of the second gripping portion has a first section and a second section facing different orientations. The first and the second sections extend linearly.

In view of the foregoing, the locking devices 40 and 40a allows the second wrench bodies 30 and 30a to be moved relative to first wrench bodies 20 and 20a rapidly. Furthermore, the locking devices 40 and 40a can selectively movable in the first position in which the second wrench bodies 30 and 30a are able to be rapidly moved toward the first wrench bodies 20 and 20a and stopped from moving away from the first wrench bodies 20 and 20a, and a second position in which the second wrench bodies 30 and 30a are able to be rapidly moved toward and away from the first wrench bodies 20 and 20a.

The foregoing is merely illustrative of the principles of this invention and various modifications can be made by those skilled in the art without departing from the scope and spirit of the invention.

What is claimed is:

1. A wrench including opening between gripping portions adjustable rapidly, comprising:
a first wrench body having a first gripping portion, a first connecting portion, and a second connecting portion;
a second wrench body having a second gripping portion, a third connecting portion, and a first engaging portion, wherein the first and the second gripping portions cooperatively delimit an opening therebetween between which a workpiece is adapted to be held, wherein the first and the third connecting portions are movably connected with each other such that the first and the second wrench bodies are movably coupled to each other, and wherein the second gripping portion is movable toward and away from the first gripping portion and the opening varies in size in response to the movement of the second wrench body relative to the first wrench body; and
a locking device coupled to the first and the second wrench bodies, wherein the locking device includes a locking member movably connected with the second connecting portion such that the locking device is movably coupled to the first wrench body, and wherein the locking member has a second engaging portion and is operably movable between a first position in which the first and the second engaging portions engage with each other and the second wrench body is able to be rapidly moved toward the first wrench body to bring the second gripping portion toward the first gripping portion and stopped from moving away from the first wrench body, and a second position in which the first and the second engaging portions disengage from each other and the second wrench body is able to be rapidly moved toward and away from the first wrench body.

2. The wrench as claimed in claim 1, wherein the locking member has at least one mounting portion movably connecting with the second connecting portion to movably connect with the second connecting portion.

3. The wrench as claimed in claim 2, wherein the second connecting portion has at least one retaining structure with which the at least one mounting portion is fit correspondingly, wherein the at least one mounting portion is in a form of a protrusion, wherein the at least one retaining structure is in a form of a slot, and wherein when the at least one mounting portion is fit with the at least one retaining structure, the slot receives the protrusion.

4. The wrench as claimed in claim 1, wherein the second connecting portion defines a cavity, wherein the cavity has a first section receiving the locking member and a second section receiving a resilient member, and wherein the locking member is biased by the resilient member.

5. The wrench as claimed in claim 1, wherein the locking device includes an actuator connected with the locking member and adapted to be input to actuate the locking member.

6. The wrench as claimed in claim 2, wherein the locking device includes an actuator connected with the locking member and adapted to be input to actuate the locking member, and wherein the actuator has at least one linking portion with which the at least one mounting portion is fit correspondingly.

7. The wrench as claimed in claim 6, wherein the at least one linking portion includes a first linking portion and a second linking portion, and wherein the actuator is U-shaped and includes an extension extending transversely between the first and the second linking portions and on which a user can apply force to operate the actuator to actuate the movement of the locking member.

8. The wrench as claimed in claim 1, wherein the opening is increasable to an extent when the second wrench body is limited from moving relative to the first wrench body, and wherein the second wrench body includes a limiter disposed thereon and the first wrench body has at least one limiting structure adapted to hold the limiter such that the limiter abuts the at least one limiting structure when the second wrench body is limited from moving relative to the first wrench body.

9. The wrench as claimed in claim 8, wherein the limiter protrudes from the third connecting portion and extends transversely to a longitudinal length the third connecting portion.

10. The wrench as claimed in claim 1, wherein the third connecting portion is inserted through the first connecting portion, and wherein the first connecting portion defines a through hole and the third connecting portion is in a form of a shaft.

11. The wrench as claimed in claim 1 further comprising a stabilizing structure to prevent the second wrench body from shaking when moving relative to the first wrench body and to smooth the relative movement of the first and the second wrench bodies, wherein one of the first and the second wrench bodies includes a stabilizer disposed thereon and movable on the other of the first and the second wrench bodies in a guided manner

12. The wrench as claimed in claim 11, wherein the other of the first and the second wrench bodies includes a guide along which the stabilizer moves.

13. The wrench as claimed in claim 12, wherein the opening is increasable to an extent when the second wrench body is limited from moving relative to the first wrench body, wherein the second wrench body includes a limiter disposed thereon and the first wrench body has at least one limiting structure adapted to hold the limiter such that the limiter abuts the at least one limiting structure when the second wrench body is limited from moving relative to the first wrench body, and wherein the at least one limiting structure includes the stabilizer disposed thereon.

14. The wrench as claimed in claim 1 further comprising an operation aid structure which allows a user to put a hand frictionally on the third connecting portion.

15. The wrench as claimed in claim 14 further comprising an operation aid structure which allows a user to put a hand frictionally on the third connecting portion.

16. The wrench as claimed in claim 14, wherein the operation aid structure has a surface which is rugged.

17. The wrench as claimed in claim 15, wherein the operation aid structure has a surface which is rugged.

18. The wrench as claimed in claim 16, wherein the surface of operation aid structure extends curvedly.

19. The wrench as claimed in claim 17, wherein the surface of operation aid structure extends curvedly.

20. The wrench as claimed in claim 1, wherein the second gripping portion is pivotally movable.
